(19) United States
(12) Patent Application Publication
(10) Pub. No.: US 2007/0266070 A1
(43) Pub. Date: Nov. 15, 2007

(54) Split-radix FFT/IFFT processor

(75) Inventors: Tze-Yun Sung, Hsinchu (TW); Yaw-Shih Shieh, Hsinchu (TW)

Correspondence Address: BACON & THOMAS, PLLC, 625 SLATERS LANE, FOURTH FLOOR, ALEXANDRIA, VA, 22314, US

(73) Assignee: Chung Hua University, Hsinchu (TW)

(21) Appl. No.: 11/432,355

(22) Filed: May 12, 2006

(51) Int. Cl. G06F 17/14

(52) U.S. Cl. 708/404

(57) ABSTRACT

This invention presents a CORDIC-based split-radix FFT/IFFT (Fast Fourier Transform/Inverse Fast Fourier Transform) processor dedicated to the computation of 2048/4096/8192-point DFT (Discrete Fourier Transform). The arithmetic unit of butterfly processor and twiddle factor generator are based on CORDIC (Coordinate Rotation Digital Computer) algorithm. An efficient implementation of CORDIC-based split-radix FFT algorithm is demonstrated. All control signals are generated internally on-chip. The modified-pipelining CORDIC arithmetic unit is employed for the complex multiplication. A CORDIC twiddle factor generator is proposed and implemented for saving the size of ROM (Read Only Memory) required for storing the twiddle factors. Compared with conventional FFT implementations, the power consumption is reduced by 25%.

### BACKGROUND OF THE INVENTION

1. Field of the Invention

This invention presents a CORDIC-based Split-radix FFT/IFFT Processor (CSFP) dedicated to the computation of 2048/4096/8192-point DFT, which can perform 2048 and 8192-point FFT for European standard and 4096-point FFT for Japanese standard.

2. Description of Background Art

Fast Fourier Transform (FFT) of digital signal processing kernel is common in real-time applications such as wireless local area network (LAN) applications. According to the European digital video/audio broadcasting standards (DVB-T/DAB), an orthogonal frequency division multiplexer (OFDM) system requires FFT (ranging from 2048 to 8192-point). New wireless local area network (WLAN) may also incorporate the OFDM system to perform higher bandwidth. Thus, the design of high throughput FFT is very essential for WLAN and digital communications.

The Very Large-Scale Integration (VLSI) implementation of FFT/IFFT is very important for real-time signal processing. C. D. Thompson proposed an efficient VLSI architecture for FFT in 1983. Wold and Despain proposed a pipeline and parallel-pipeline FFT processor for VLSI implementation in 1984. Widhe proposed and implemented the efficient FFT processing elements in 1997. They proposed several efficient architectures and VLSI implementations for FFT. Different FFT algorithms, such as the radix-2, radix-4 and split-radix FFT algorithm, which reduce the number of computations, have been proposed. The radix-2 and radix-4 approaches decomposed the N-point DFT computations into sets of two and four-point DFTs, respectively. To take advantage of computation efficiency, the split-radix FFT algorithm uses both radix-2 and radix-4 decomposition. The computation efficiency of the split-radix FFT (SRFFT) algorithm has been proven, but there has been little research on hardware implementation of SRFFT based on CORDIC (Coordination Rotation Digital Computer) algorithm.

In the twiddle factor multiplications for larger transforms, the Booth multiplier is not efficient because it requires large ROM (Read Only Memory) for storing twiddle factors. In order to obviate large ROM, we employ a complex multiplier based on CORDIC algorithm. To the best of our knowledge, the proposed CORDIC-based split-radix FFT processor is the first in literature.

### SUMMARY OF THE INVENTION

This invention provides a novel CORDIC-based split-radix FFT architecture; that is very suitable for any-point FFT and OFDM systems. The architecture is based on split-radix FFT algorithm to perform modular structure. The 2048-, 4096-, and 8192-point FFT is easily implemented and achieved. The modified-pipelining CORDIC arithmetic unit is employed for twiddle factor complex multiplication. In order to save ROM, the CORDIC twiddle factor generator (CTFG) is proposed and implemented.

The CORDIC-based 2048/4096/8192-point split-radix FFT processor is fabricated in 0.18 μm CMOS (Complementary Metal Oxide Semiconductor) and contains 200,822 gates. The processor performs 8192-point FFT/IFFT (Fast Fourier Transform/inverse Fast Fourier Transform) every 138 μs, 4096-point FFT/IFFT every 69 μs and 2048-point FFT/IFFT every 34.5 μs, respectively, the symbol rate exceeds the requirement of OFDM (Orthogonal Frequency Division Multiplexer).

The CORDIC-based FFT processor, whose applicability for OFDM system has been proven, is designed using portable and reusable Verilog®. The processor is a reusable IP (Intellectual Property), which is implemented in various processes and in combination with an efficient use of the hardware resources available in the target systems leading to various performance, area and power consumption trade-offs.

### BRIEF DESCRIPTION OF THE DRAWING

The present invention will become better understood with reference to the accompanying drawings which are given only by way of illustration and thus are not limitative of the present invention, wherein:

FIG. 1 shows the proposed FFT architecture;

FIG. 2 shows the SRFFT processor [composed of butterfly processor-I (BFP-I) and butterfly processor-II (BFP-II)];

FIG. 3 shows the Split-radix FFT and data-flow map with BFP-I, BFP-II, CORDIC;

FIG. 4 shows the twiddle factor generation method;

FIG. 5 shows the CORDIC twiddle factor generator (the modified-pipelining CORDIC arithmetic unit operates the rotation mode in linear coordinate system, where the constant in FIG. 6(a) is replaced by 2⁻¹);

FIG. 6 shows the modified-pipelining CORDIC arithmetic unit [(a) i-th stage CORDIC arithmetic unit (rotation mode in the circular coordinate system), (b) the modified CORDIC arithmetic unit with pre-scalar and pipelining stages];

FIG. 7 shows the hardware architecture of 8192-point FFT/IFFT processor; and

FIG. 8 shows the log-log plot of the CORDIC computations versus number of points for each algorithm.

### BEST MODE FOR CARRYING OUT THE INVENTION

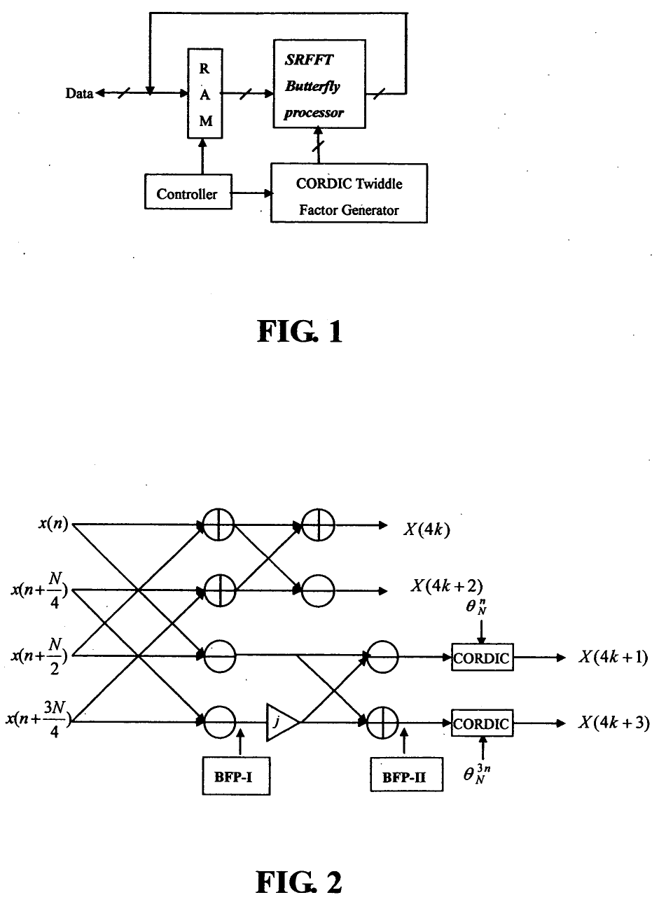

FIG. 1 shows the proposed FFT architecture. The FFT architecture consists of SRFFT butterfly processor, eight-port SRAM (Static Random Access Memory) for storing input data and the results (complex-valued numbers), twiddle factor generator, controller and register file.

In this architecture, using the same SRAM for input and output allows memory-efficiency, called an “in-place” computation algorithm. Moreover, the proposed architecture can compute different-point FFTs from 2048- to 8192-point.

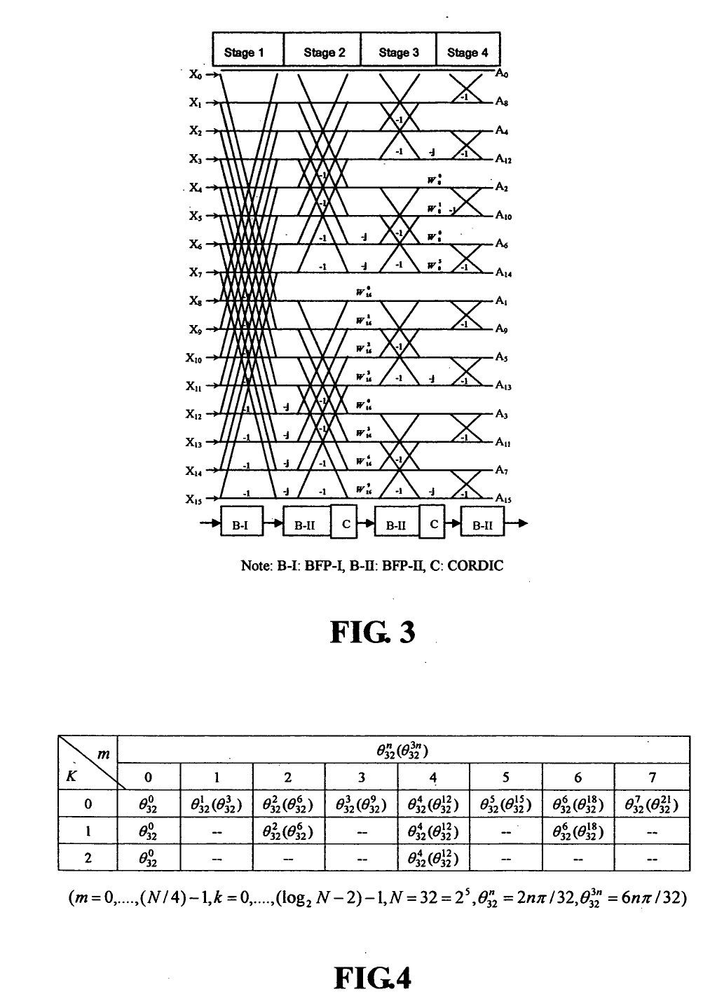

The butterfly computation is the basic operator of an FFT processor. The butterfly processor computes four-point split-radix FFT by receiving four data words from the memory. The butterfly processor computes on the complex fixed-point data and the word length of the real and imaginary parts is 16-bit. The split-radix butterfly processor based on decimation-in-frequency algorithm, the butterfly processor computes four complex additions, four complex subtractions and two modified CORDIC arithmetic units as it is shown in FIG. 2. The SRFFT butterfly processor consists of butterfly processor-I (BFP-I), butterfly processor-II (BFP-II) and two modified-pipelining CORDIC arithmetic units. The 16-point split-radix FFT is shown in FIG. 3. The modified-pipelining CORDIC arithmetic unit is employed for the complex multiplication.

In the circular coordinate system of CORDIC, the rotation mode can be represented as

$$[ \begin{matrix}{x}_{n} \\ {y}_{n}\end{matrix} ] = {K}_{c} [ \begin{matrix}cos {z}_{0} & sin {z}_{0} \\ - sin {z}_{0} & cos {z}_{0}\end{matrix} ] [ \begin{matrix}{x}_{0} \\ {y}_{0}\end{matrix} ] \qquad ( 1 )$$

where [x₀ y₀] is the input vector, z₀ is the rotation angle, K_{c} is the scale factor, and [xₙ yₙ] is the output vector.

Since K_{c} is a constant, the scaling can be pre-processed or processed in parallel. The modified circular rotation computation can be embedded into complex multiplication with e^{-jθ} as

$$[ \begin{matrix}Re [ {X}^{′} ] \\ Im [ {X}^{′} ]\end{matrix} ] = [ \begin{matrix}cos θ & sin θ \\ - sin θ & cos θ\end{matrix} ] [ \begin{matrix}Re [ X ] \\ Im [ X ]\end{matrix} ] \qquad ( 2 )$$

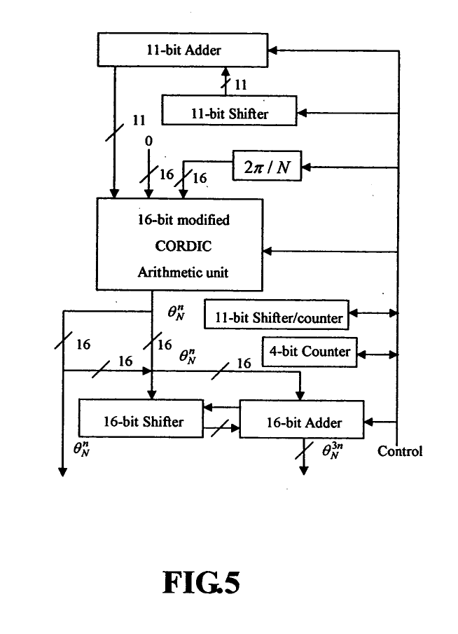

The conventional complex multiplier is not efficient because it requires large ROM (Read Only Memory) for storing the twiddle factors. We employ a complex multiplier based on the CORDIC algorithm; the ROM should be saved, but still needs more ROM for storing a set of predefined elementary rotation angles. Now, we develop a twiddle factor generation method, which can obviate the ROM required for storing twiddle factors and is described in FIG. 4. The twiddle factor generator produces N/4 twiddle factors at the first stage, N/8 factors at the second stage and so on. At the last stage, the generator produces two factors. The number of stages is k(=log₂ N−2), and the θ_{N}ⁿ's for k-th stage are θ_{N}⁰, . . . , θ_{N}²^{((N/(4-2}^{^{k}}⁾⁾⁻¹⁾. The twiddle factor generation method is very regular. Thus, the twiddle factor generator is easily implemented by using an adder and shifter for performing n, both of them are 11-bit and must be preloaded 0 and 1 at an initial state, respectively. The modified-pipelining CORDIC arithmetic unit for computing the twiddle factor θ_{N}ⁿ(=2nπ/N) in the rotation mode in linear coordinate system and the 16-bit adder and 16-bit shifter for performing the twiddle factor θ_{N}³ⁿ(=6nπ/N) are shown in FIG. 5. In FIG. 5, the 4-bit counter counts the number of stages, and the 11-bit shifter and 11-bit counter perform the number of factors for each stage and count the number. The computations of twiddle factors (θ_{N}ⁿ, θ_{N}³ⁿ) and butterfly are processed in parallelism and pipeline. Thus, an extra time is not required for the proposed system. The large ROM is obviated and the chip area is reduced significantly, however an additional logic circuit is required. The number of gates required for the full-ROM of twiddle factor and the CORDIC twiddle factor generator are comparable as summarized in Table II. The number of gates required for the semi-ROM of twiddle factor and the CORDIC twiddle factor generator are comparable as summarized in Table III. The power consumption and chip area are also obviously reduced.

The single SRFFT butterfly processor used here to compute the number of CORDIC computations for an N(=2ⁿ)-point FFT is

$$\begin{matrix}{M}_{single - processor} = ( {\sum }_{m = 0}^{( n - 2 ) - 1} \frac{N}{4 \cdot {2}^{m}} ) + 1 \\ = \frac{N}{4} ( 2 - {2}^{- n + 2} ) + 1 \\ = \frac{N}{4} ( 2 - {2}^{- ( {log}_{2} N - 2 )} ) + 1\end{matrix} \qquad ( 3 )$$

Thus, the computation complexity is O((N/4)(2−2^{-(log}^{₂}^{N-2)})+1), which is in accordance with a single SRFFT butterfly processor.

In multiprocessor system for spit-radix FFT, the k-SRFFT butterfly processor used here to compute the number of CORDIC computations for an N(=2ⁿ)-point FFT is

$${M}_{k - processor} = \frac{N}{k \cdot 4 \cdot {2}^{0}} + … + \frac{N}{k \cdot 4 \cdot {2}^{m}} + … + 1 \qquad ( 4 )$$

$$where m \text{-} th item = 1 , k \geq ( \frac{N}{4 \cdot {2}^{m}} ) , \\ and m \text{-} th item = \frac{N}{k \cdot 4 \cdot {2}^{m}} , k < ( \frac{N}{4 \cdot {2}^{m}} ) .$$

Thus, the solution of the proposed architecture has parallelism and sequential processing. The computation complexity is O(log₂ N−2), which is in accordance with N/4 SRFFT (split-radix FFT) butterfly processors.

We can select an inefficient extreme in the area and high performance as the number of points increases with N/4 SRFFT butterfly processors with one stage, or an inefficient extreme in performance and saving chip area as the number of points increases with a single butterfly processor with N/4 stages.

The CSFP (CORDIC-based Split-radix FFT/IFFT Processor) providing 2048-point to 8192-point FFT/IFFT computation can be programmed by a master controller. The computation complexity of a single processor becomes O((N/4)(2−2^{-(log}^{₂}^{N-2)})+1). We also can cascade log₂ N butterfly processors in series to execute FFT in parallelism and pipeline. The computation complexity also becomes O(N/4), and the latency time is ((N/4)(2−2^{-(log}^{₂} ^{N-2)})+1) CORDIC computations.

In this paper, the FFT application of the rotation mode of CORDIC circular coordinate system is considered, and all the twiddle factor multiplications in FFT are formulated as a rotation of a 2×1 vector in the circular coordinate system. The overall relative error is less than 10⁻³, when the bit-number of registers is defined by 16-bit, the number of iterations or stages of CORDIC processor is determined to be 12. The modified-pipelining CORDIC arithmetic unit is unfolded into 12-stage pipelined architecture for 16-bit accuracy. Here, K_{c}≈1.64676 is a pre-calculated scaling factor, so the modified-pipelining CORDIC arithmetic has an additional stage to pre-calculate the scaling factor.

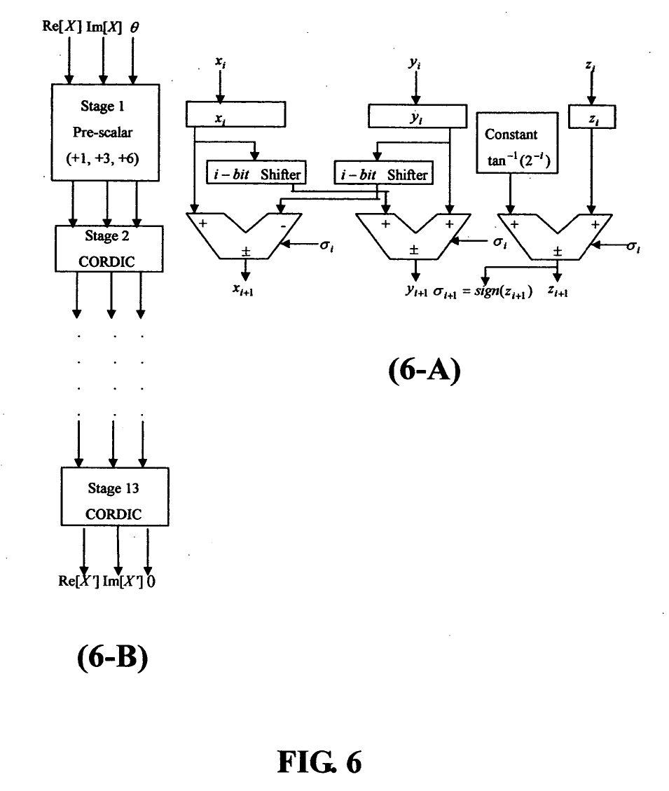

Thus, we propose the modified-pipelining CORDIC arithmetic unit to save power to compute complex multiplication. The number of gates required for complex multiplier and modified-pipelining CORDIC arithmetic unit is comparable as summarized in Table I. The power consumption of the modified-pipelining CORDIC arithmetic unit is reported by PowerMill®. Compared with a complex multiplication implementation, the power consumption of the modified-pipelining CORDIC arithmetic unit is reduced by 25%. The modified-pipelining CORDIC arithmetic unit providing parallel-pipelined computation is shown in FIG. 6.

In most digital signal processing applications, the performance is mainly determined by the throughput rather than the latency, so we partition the CORDIC operation into thirteen pipelined stages. The system accomplished by modified-pipelining CORDIC arithmetic also performs high-throughput and pipelined architecture.

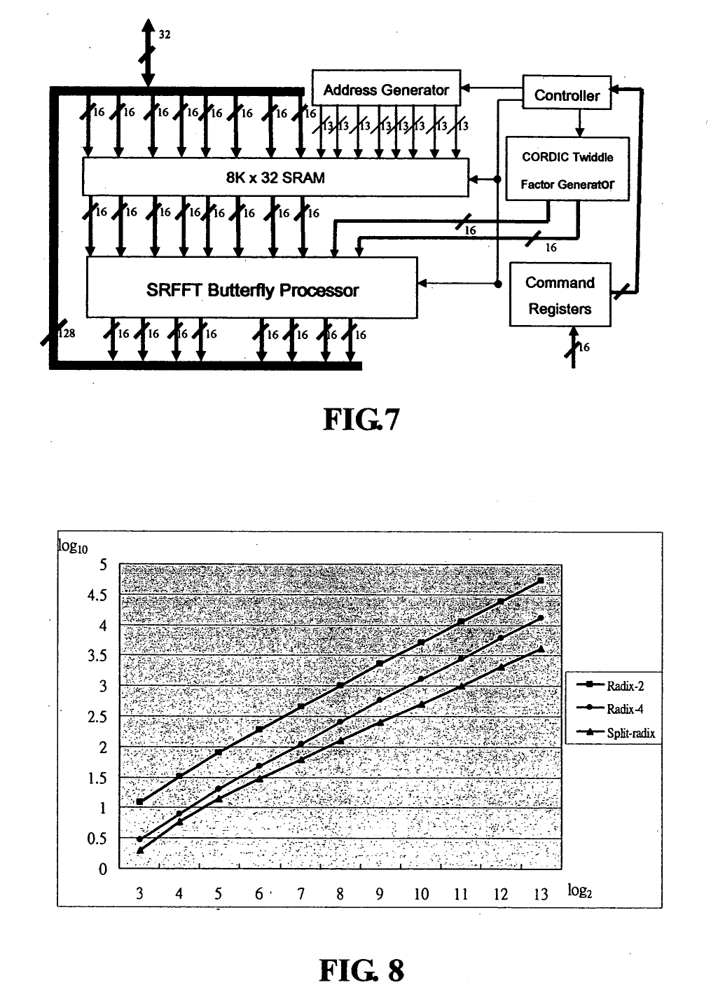

The programmable 8192-point split-radix FFT/IFFT processor involves 16-bit SRFFT butterfly processor, eight-port SRAM (8K×32), CORDIC twiddle factor generator, address generator for eight-port SRAM, and system controller. The CORDIC twiddle factor generator is implemented by using the modified-pipelining CORDIC arithmetic unit, and the system controller is implemented by using the counter and finite state machine (FSM). In order to overcome the bottleneck of data I/O within computation, the CSFP provides an eight-port SRAM. The hardware architecture of 8192-point split-radix FFT/IFFT processor is shown in FIG. 7. This processor can be programmed to compute 2048-, 4096- and 8192-point FFT.

The functional simulator is written in C⁺⁺ running on a PC (Personal Computer). It is designed to simulate the bit-level arithmetic operations of CORDIC arithmetic so that the quantization error may be analyzed and computed explicitly. The hardware design of the modified-pipelining CORDIC arithmetic unit achieves smaller area and higher performance.

The hardware code is written in Verilog® running on SUN Blade 1000 workstation under the ModelSim® simulation tool and Synopsys® synthesis tool. The chip is synthesized by TSMC (Taiwan SeMiconductor Co.) 0.18 μm CMOS (Complementary Metal Oxide Semiconductor) cell libraries. The gate count is reported by the Synopsys® design analyzer, and the power consumption is reported by PowerMill®. The core size is 4860 μm×7883 μm and contains about 200,822 gate counts, and the power dissipation is 350 mW with the clock rate of 150 MHz at 1.8V. All control signals are generated internally on-chip. The chip provides high throughput under a low-gate count, and this work utilizes a parallel-pipelined architecture. Compared with the conventional CORDIC-based radix-2 FFT processor, the power consumption of CSFP is reduced by 25% at 150 MHz at 1.8V. This power consumption is also reported by PowerMill®.

This invention presents a novel CORDIC-based split-radix FFT architecture; that is very suitable for any-point FFT and OFDM systems. The architecture is based on split-radix FFT algorithm to perform modular structure. The 2048-, 4096-, and 8192-point FFT is easily implemented and achieved. The modified-pipelining CORDIC arithmetic unit is employed for twiddle factor complex multiplication. In order to save ROM, the CORDIC twiddle factor generator (CTFG) is proposed and implemented.

The comparison of computation complexity of radix-2, radix-4 and split-radix and CORDIC computations is in Table IV. In this table, split-radix FFT has less number of CORDIC computations and better computation complexity. The log-log plot of the CORDIC computations versus number of points for each algorithm is shown in FIG. 8. In FIG. 8, the split-radix FFT improves the speed obviously.

Finally, the CORDIC-based 2048/4096/8192-point split-radix FFT processor is fabricated in 0.18 μm CMOS and contains 200,822 gates. The processor performs 8192-point FFT/IFFT every 138 μs, 4096-point FFT/IFFT every 69 μs and 2048-point FFT/IFFT every 34.5 μs, respectively, the symbol rate exceeds the requirement of OFDM.

The CORDIC-based FFT processor, whose applicability for OFDM system has been proven, is designed using portable and reusable Verilog®. The processor is a reusable IP (Intellectual Property), which is implemented in various processes and in combination with an efficient use of the hardware resources available in the target systems leading to various performance, area and power consumption trade-offs.

TABLE I
Hardware requirements and comparison of complex multiplier
and the modified-pipelining CORDIC arithmetic unit

| Arithmetic | Complex multiplier | Modified-pipelining |
|---|---|---|
| unit | (4-real Booth multiplier) | CORDIC arithmetic unit |
| Gate counts | ˜32,000 gates | ˜18,000 gates |

TABLE II
Hardware requirements of full-twiddle factor ROM and CTFG

| | Device | | | | | | | |
|---|---|---|---|---|---|---|---|---|
| | Full-twiddle factor ROM | | | | | | | |
| | θ_{N}ⁿ, θ_{N}³ⁿ | | | CORDIC twiddle factor generator (CTFG) | | | | |
| | 8192-point | | | θ_{N}ⁿ, θ_{N}³ⁿ | | | | |
| | ROM | 11-bit | 11-bit | 16-bit | 16-bit | 16-bit | 11-bit | 11-bit |
| Processor | θ_{N}ⁿ, θ_{N}³ⁿ | Shifter | Adder | CORDIC | Adder | Shifter | Shifter | Adder |
| Gates | 4K × 12-bit | ˜50 | ˜150 | ˜18K | ˜200 | ˜90 | ˜50 | ˜150 |
| | | gates | gates | gates | gates | gates | gates | gates |

Note:
1 - bit ≈ 1 - gate

TABLE III
Hardware requirements of semi-twiddle factor ROM and CTFG

| | Device | | | | |
|---|---|---|---|---|---|
| | Semi-twiddle factor ROM θ_{N}ⁿ, θ_{N}³ⁿ | | | | |
| | 8192-point | 16-bit | 16-bit | 11-bit | 11-bit |
| Processor | ROM θ_{N}ⁿ | Adder | Shifter | Shifter | Adder |
| Gates | 2K × 12-bit | ˜200 gates | ˜90 gates | ˜50 gates | ˜150 gates |

CORDIC twiddle factor generator (CTFG) θ_{N}ⁿ, θ_{N}³ⁿ

| 16-bit | 16-bit | 16-bit | 11-bit | 11-bit |
|---|---|---|---|---|
| CORDIC | Adder | Shifter | Shifter | Adder |
| ˜18K gates | ˜200 gates | ˜90 gates | ˜50 gates | ˜150 gates |

Note:
1 - bit ≈ 1 - gate

TABLE IV
Comparison of CORDIC-based radix-2, radix-4 and split-radix
FFT

| N-point FFT (CORDIC-based) | Computation complexity of single butterfly processor | $Computation complexity of \frac{N}{4} butterfly processors$ | Number of CORDIC computations |
|---|---|---|---|
| Radix-2 [11] | O((N/2)log₂ N) | O(log₂ N) | (N/2)log₂ N |
| Radix-4 [11] | O((N/4)log₄ N) | O(log₄ N) | (N/4)log₄ N |
| Split-radix | $O ( ( N / 4 ) ( 2 - {2}^{- ( {log}_{2} N - 2 )} ) + 1 )$ | O(log₂ N − 2) | $( N / 4 ) ( 2 - {2}^{- ( {log}_{2} N - 2 )} ) + 1$ |

We claim:

1. A coordinate rotation digital computer-based split-radix fast fourier transform/inverse fast fourier transform (FFT/IFFT) processor, comprising:
a processor dedicated to the computation of 2048/4096/8192-point discrete fourier transform (DFT);
a processor which it all control signals are generated internally on-chip; and
a modified-pipelining coordinate rotation digital computer (CORDIC) arithmetic unit is employed for the complex multiplication and twiddle factor generator.

2. A processor as in claim 1 consists of split-radix fast fourier transform butterfly processor, eight-port static random access memory (SRAM) for storing inputted data and the results (complex-valued numbers), twiddle factor generator, controller and register file.

3. A processor as in claim 1 using the same SRAM to process input and output that rise efficiency of memory, which is called an “in-place” computation algorithm.

4. A processor as in claim 1 can compute different-point FFTs from 2048- to 8192-point.

5. A hard architecture of the processor as in claim 1 wherein the programmable 8192-point split-radix fast fourier transform/inverse fast fourier transform (FFT/IFFT) processor involves 16-bit split-radix FFT (SRFFT) butterfly processor, eight-port SRAM (8K×32), CORDIC twiddle factor generator, address generator for eight-port SRAM, and system controller.

6. A CORDIC twiddle factor generator as in claim 1 is implemented by using the modified-pipelining CORDIC arithmetic unit, and the system controller is implemented by using the counter and finite state machine (FSM); in order to overcome the bottleneck of data I/O within computation, the CORDIC-based split-radix FFT/IFFT processor (CSFP) provides an eight-port SRAM; this processor can be programmed to compute 2048-, 4096- and 8192-point FFT.

7. A processor as in claim 1 wherein the butterfly computation is the basic operator of an FFT processor, the butterfly processor computes four-point split-radix FFT by receiving four data words from the memory; the butterfly processor computes on the complex fixed-point data and the word length of the real and imaginary parts is 16-bit; the split-radix butterfly processor based on decimation-in-frequency algorithm, the butterfly processor computes four complex additions, four complex subtractions and two modified CORDIC arithmetic units; the split-radix FFT (SRFFT) butterfly processor consists of butterfly processor-I (BFP-I), butterfly processor-II (BFP-II) and two modified-pipelining CORDIC arithmetic units.

8. A CORDIC twiddle factor generator as in claim 1 wherein the twiddle factor generator produces n/4 twiddle factors at the first stage, n/8 factors at the second stage and so on, at the last stage, the generator produces two factors, the number of stages is k(=log₂ N−2), and the θ_{N}ⁿ's for k-th stage are θ_{N}⁰, . . . , θ_{N}²^{^{k}}^{-(N/(4-2}^{^{k}}⁾⁾⁻¹⁾; the twiddle factor generation method is very regular, thus, the twiddle factor generator is easily implemented by using an adder and shifter for performing n, both of them are 11-bit and must be preloaded 0 and 1 at an initial state, respectively.

9. A processor as in claim 1 wherein the modified-pipelining CORDIC arithmetic unit for computing the twiddle factor θ_{N}ⁿ(=2nπ/N) in the rotation mode in linear coordinate system and the 16-bit adder and 16-bit shifter for performing the twiddle factor θ_{N}³ⁿ(=6nπ/N).

10. A CORDIC twiddle factor generator as in claim 10 wherein the 4-bit counter counts the number of stages, and the 11-bit shifter and 11-bit counter perform the number of factors for each stage and count the number.

11. A CORDIC twiddle factor generator as in claim 10 wherein the computations of twiddle factors (θ_{N}ⁿ, θ_{N}³ⁿ) and butterfly are processed in parallelism and pipeline.
